(19) United States
(12) Patent Application Publication
(10) Pub. No.: US 2016/0182816 A1
(43) Pub. Date: Jun. 23, 2016

(54) PREVENTING PHOTOGRAPHS OF UNINTENDED SUBJECTS

(71) Applicant: eBay Enterprise, Inc., King of Prussia, PA (US)

(72) Inventors: Bryant Genepang Luk, Round Rock, TX (US); Richard Chapman Bates, Austin, TX (US); Christopher Diebold O'Toole, Cedar Park, TX (US); Robert He, Pflugerville, TX (US); Jennifer T. Brenner, Austin, TX (US); Yu Tang, Round Rock, TX (US); Jason Ziaja, Cedar Park, TX (US); Ananya Das, Austin, TX (US)

(21) Appl. No.: 14/582,026

(22) Filed: Dec. 23, 2014

(51) Int. Cl. H04N 5/232

(52) U.S. Cl. CPC H04N 5/23219

(57) ABSTRACT

Systems and methods are presented for identifying unintended subjects in an image to be captured and causing an action based on the unintended subjects. In some embodiments, the system receives image data indicative of an image to be captured, determines a first set of subjects within the image data, determines an identity of a second set of subjects included in the first set of subjects within the image data, and determined an existence of one or more unidentified subjects of the first set of subjects. The system then generates an interrupt indicative of the one or more unidentified subjects of the first set of subjects.

### TECHNICAL FIELD

The subject matter disclosed herein generally relates to photography. Specifically, the present disclosure addresses systems and methods for identifying the presence of unintended subjects and preventing photographs from being taken while the unintended subjects are within the frame of the photograph.

### BACKGROUND

Cameras and devices containing cameras are used to capture images of individuals and groups. Individuals often take candid images of themselves called a “selfie.” Groups take candid and posed photographs, some of which employ a time delay function of the camera or device. A recent cultural phenomenon is the photobomb, where individuals insert themselves into the candid or posed photographs of others. Often, photobombers, individuals engaging in the practice of performing a photobomb, pose in outlandish or undesirable ways or perform undesirable acts. Some individuals attempt to avoid photobombs, while some individuals are spurred to recapture a photograph in response to a photobomb.

### BRIEF DESCRIPTION OF THE DRAWINGS

Some embodiments are illustrated by way of example and not limitation in the figures of the accompanying drawings.

FIG. 1 is a network diagram illustrating a network environment suitable for identifying unintended subjects in a photograph to be taken and causing an action based on the unintended subjects, according to some example embodiments.

FIG. 2 is a block diagram illustrating components of a mobile device according to some example embodiments, able to read instructions from a machine-readable medium and perform any one or more of the methodologies discussed herein.

FIG. 3 is a block diagram illustrating components of a device suitable for identifying unintended subjects in a photograph to be taken and causing an action based on the unintended subjects, according to some example embodiments.

FIG. 4 is a flowchart illustrating operations of a device in performing a method of identifying unintended subjects in a photograph to be taken and causing an action based on the unintended subjects, according to some example embodiments.

FIG. 5 is a flowchart illustrating operations of a device in performing a method of identifying unintended subjects in a photograph to be taken and causing an action based on the unintended subjects, according to some example embodiments.

FIG. 6 is a flowchart illustrating operations of a device in performing a method of identifying unintended subjects in a photograph to be taken and causing an action based on the unintended subjects, according to some example embodiments.

FIG. 7 is a block diagram illustrating components of a machine, according to some example embodiments, able to read instructions from a machine-readable medium and perform any one or more of the methodologies discussed herein.

### DETAILED DESCRIPTION

Example methods and systems are directed to identifying unintended subjects in a photograph to be taken and causing an action based on the unintended subjects. In some embodiments, the unintended subjects of the photograph can be a set of unidentified subjects within a set of subjects of image data indicative of a photograph to be taken. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

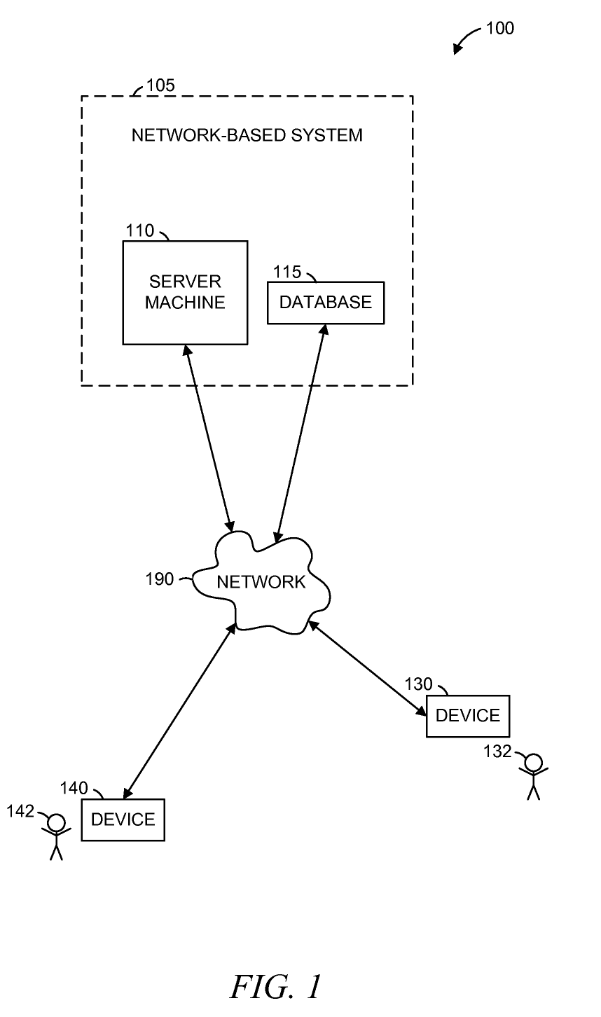

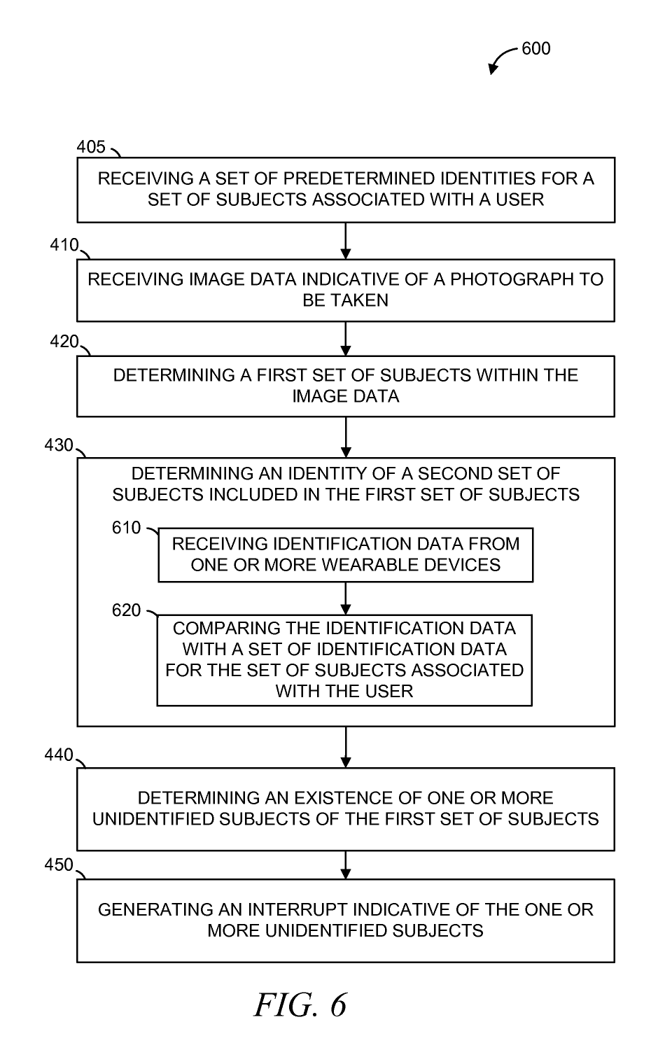

FIG. 1 is a network diagram illustrating a network environment 100 suitable for identifying unintended subjects in a photograph to be taken and causing an action based on the unintended subjects, according to some example embodiments. The network environment 100 includes a server machine 110, a database 115, and devices 130 and 140, all communicatively coupled to each other via a network 190. The server machine 110 may form all or part of a network-based system 105 (e.g., a cloud-based server system configured to provide one or more services to the devices 130 and 140). The server machine 110 and the devices 130 and 140 may each be implemented in a computer system, in whole or in part, as described below with respect to FIG. 6.

In some embodiments, the server machine 110 can be a server, web server, database, or other machine capable of receiving and processing information, such as image data. The server machine 110 can be a portion of a social media system, website, or database. In some embodiments, the server machine 110 can include software and hardware capable of performing facial recognition analysis of image data. Further, in some embodiments, the server machine 110 can include non-transitory machine readable media containing information indicative of a user and subjects associated with the user. For example, the data indicative of the subjects can include facial profiles for the subjects and the user, one or more characteristics used for facial recognition analysis, identification data, and other suitable identifying data. In some embodiments, at least a portion of the identification data can be wearable device identification data associated with the subjects and the user.

Also shown in FIG. 1 are users 132 and 142. One or both of the users 132 and 142 may be a human user (e.g., a human being), a machine user (e.g., a computer configured by a software program to interact with the device 130), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, a smartphone, or a wearable device (e.g., a smart watch or smart glasses) belonging to the user 132. Likewise, the user 142 is not part of the network environment 100, but is associated with the device 140. As an example, the device 140 may be a desktop computer, a vehicle computer, a tablet computer, a navigational device, a portable media device, a smartphone, or a wearable device (e.g., a smart watch or smart glasses) belonging to the user 142.

Any of the machines, databases, or devices shown in FIG. 1 may be implemented in a general-purpose computer modified (e.g., configured or programmed) by software (e.g., one or more software modules) to be a special-purpose computer to perform one or more of the functions described herein for that machine, database, or device. For example, a computer system able to implement any one or more of the methodologies described herein is discussed below with respect to FIG. 6. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

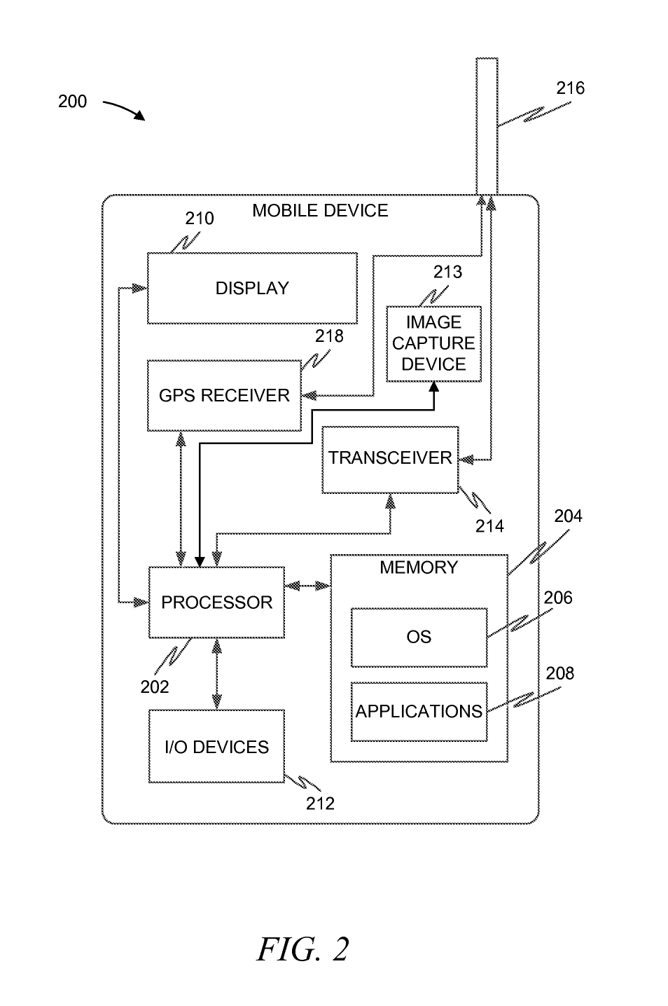

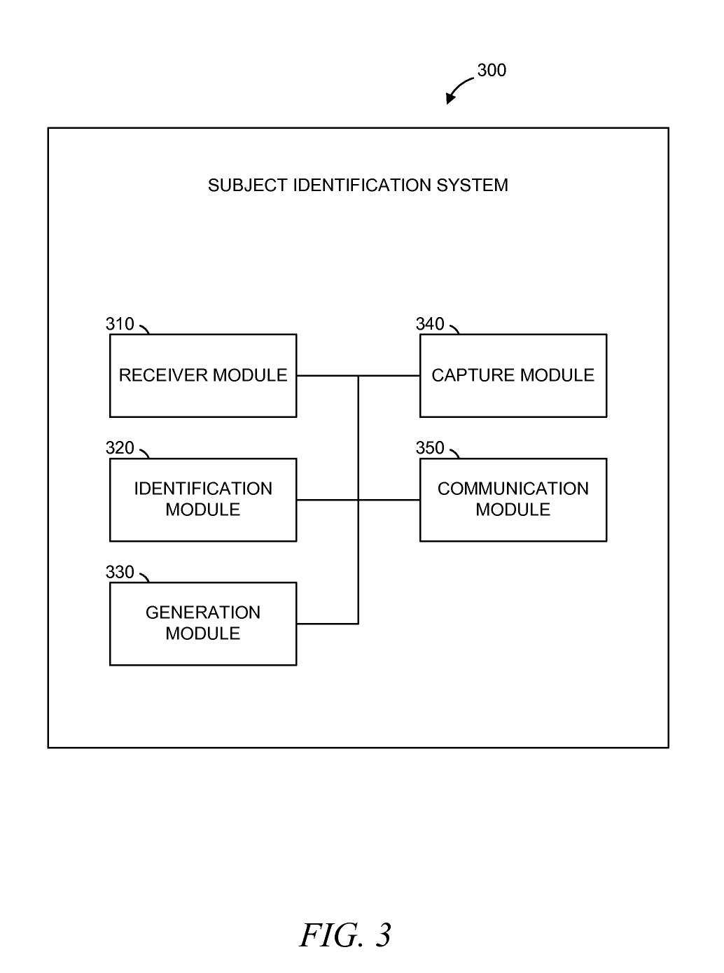

FIG. 2 is a block diagram illustrating a mobile device 200, according to some example embodiments. For example, the mobile device 200 may be an implementation of the device 130. The mobile device 200 is configured to perform any one or more methodologies discussed herein with respect to the user device 130. For example, the mobile device 200 can receive image data, determine a first set of subjects within the image data and an identity of a second set of subjects included in the first set of subjects, determine the existence of one or more unidentified subjects of the first set of subjects within the image data, generate an interrupt indicative of the one or more unidentified subjects of the first set of subjects, and capture the image data depicting the first set of subjects. The mobile device 200 can include or components within the mobile device 200 can be configured to act as one or more of the modules discussed below with respect to FIG. 3.

The mobile device 200 can include a processor 202. In some embodiments, the processor 202 may be implemented as one or more processor 202. The processor 202 can be any of a variety of different types of commercially available processors suitable for mobile devices 200 (for example, an XScale architecture microprocessor, a Microprocessor without Interlocked Pipeline Stages (MIPS) architecture processor, or another type of processor). A memory 204, such as a random access memory (RAM), a Flash memory, or other type of memory, is typically accessible to the processor 202. The memory 204 can be adapted to store an operating system (OS) 206, as well as application programs 208, such as a mobile location enabled application that can provide location based services to a user. The processor 202 can be coupled, either directly or via appropriate intermediary hardware, to a display 210 and to one or more input/output (I/O) devices 212, such as a keypad, a touch panel sensor, a microphone, and the like, and an image capture device 213. The image capture device 213 can form a portion of a subject identification system 300, described with respect to FIG. 3. The subject identification system 300 can receive image data, from the image capture device 213; determine unidentified subjects within the image data; and perform one or more operation based on an interrupt indicative of the one or more unidentified subjects.

In some example embodiments, the processor 202 can be coupled to a transceiver 214 that interfaces with an antenna 216. The transceiver 214 can be configured to both transmit and receive cellular network signals, wireless data signals, or other types of signals via the antenna 216, depending on the nature of the mobile device 200. Further, in some configurations, a GPS receiver 218 can also make use of the antenna 216 to receive GPS signals.

It should be noted that, in some embodiments, the mobile device 200 can include additional components or operate with fewer components than described above. Further, in some embodiments, the mobile device 200 may be implemented as a camera with some or all of the components described above with respect to FIG. 2. For example, the mobile device 200 can be a point and shoot digital camera, a digital single-lens reflex camera (DSLR), a film single-lens reflex camera (SLR), or any other suitable camera capable of performing at least a portion of the methodologies described in the present disclosure.

The mobile device 200 can be configured to perform any one or more of the methodologies discussed herein. For example, the memory 204 of the mobile device 200 may include instructions comprising one or more modules for performing the methodologies discussed herein. The modules can configure the processor 202 of the mobile device 200, or at least one processor where the mobile device 200 has a plurality of processors, to perform one or more of the operations outlined below with respect to each module. In some embodiments, the mobile device 200 and the server machine 110 can each store at least a portion of the modules discussed above and cooperate to perform the methods of the present disclosure, as will be explained in more detail below.

FIG. 3 is a block diagram illustrating modules of a subject identification system 300, according to some example embodiments. The subject identification system 300 is shown as including a receiver module 310, an identification module 320, a generation module 330, a capture module 340, and a communication module 350, all configured to communicate with each other (e.g., via a bus, shared memory, or a switch). The subject identification system 300 can form a portion of the device 130 or be distributed between the device 130 and the server machine 110.

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. For example, as referenced above with respect to FIG. 2, in some embodiments, the server machine 110 can store one or more modules or portions of the modules and cooperate with the device 130 to perform the methods described below.

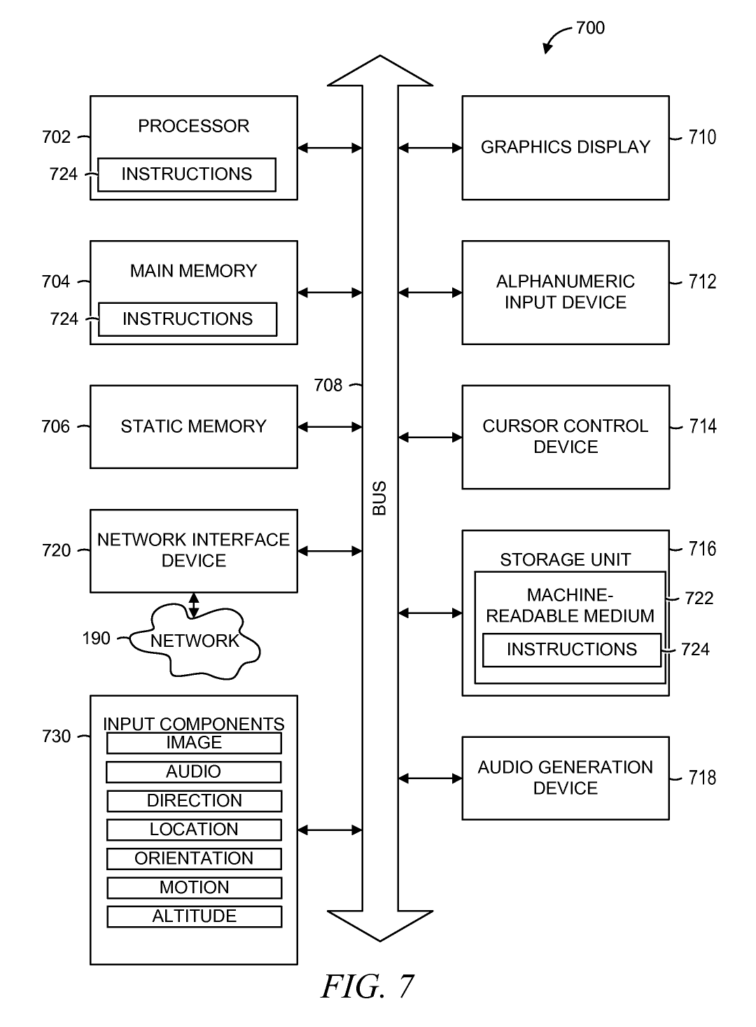

The receiver module 310 receives image data indicative of an image to be captured. The receiver module 310 can also receive a set of predetermined identities. The set of predetermined identities which may correspond to one or more subjects of a set of subjects depicted within the image data. The set of predetermined identities can be received from a contact list associated with the image capture device, from a social media site, one or more wearable computing devices associated with one or more of the set of subjects. The receiver module 310 can receive the image data from the image capture device 213 of the device 130. For example, the image capture device 213 can comprise hardware components including an image sensor (e.g., charge-coupled device (CCD) or complementary metal-oxide-semiconductor (CMOS)). The image sensor can detect the image data of the photograph to be taken and the image capture device 213 can pass the image data to the receiver module 310. In some embodiments, the receiver module 310 can comprise a portion of the image capture device 213 or the image capture device 213 can comprise a portion of the receiver module 310. Further, in some instances, the receiver module 310 can communicate with the image capture device 213 and the determination module 320 via the communication module 350. The receiver module 310 can be a hardware implemented module, a software implemented module, or a combination thereof. An example embodiment of components of the receiver module 310 is described with respect to the module of FIG. 7, described in further detail below.

The image data indicative of the image to be captured can be image data already captured by the image capture device 213, where the methods described herein relate to performing an operation performing an operation on the image data to exclude or obscure one or more unidentified subjects within the image data already captured or recapture the image data based on the presence of the one or more unidentified subjects. In some embodiments, the image capture device 213 can receive image data and pass the image data to the display 210 (e.g., live preview) without storing the image data into the memory 204 of the mobile device 200. In these instances, the subject identification system 300 can perform one or more operations in response to the existence of the one or more unidentified subjects within the image data, prior to capturing the image data, as described in more detail below.

The identification module 320 determines a first set of subjects within the image data and an identity of a second set of subjects included in the first set of subjects. The identification module 320 can match the identity of the second set of subjects to one or more identity of the set of predetermined identities, and determine an existence of one or more unidentified subject of the first set of subjects within the image data. The identification module 320 can match, correspond, associate, or otherwise determine the identity of the second set of subjects to identities of the set of predetermined identities by a comparison of identities associated with wearable computing devices proximate to one or more of the subjects of the second set of subjects. The identification module 320 can also determine the identity of the second set of subjects via facial recognition among facial profiles associated with the set of predetermined identities and the subjects depicted within the image data. The identification module 320 can be a hardware implemented module, a software implemented module, or a combination thereof, described in more detail below with respect to the module of FIG. 7.

The generation module 330 generates an interrupt indicative of the one or more unidentified subjects of the first set of subjects. For example, the interrupt can be in the form of an instruction, signal, command, initiating event, or other prompt indicative of the unidentified subjects. The interrupt can cause processes within the device 130 to cease or be temporarily delayed to perform an action specified by the interrupt. For example, actions associated with the interrupt can include generating a signal (e.g., light or sound) indicative of the unidentified subjects, generating an alert, capturing an image, recapturing an image, or other suitable actions. The generation module 330 can be a hardware implemented module, a software implemented module, or a combination thereof. For example, the generation module 330 can be implemented similarly to the module described with respect in FIG. 7.

The capture module 340 captures the image data depicting the first set of subjects. The capture module 340 can be a hardware implemented module, a software implemented module, or a combination thereof, described in more detail below with respect to the module of FIG. 7. In some instances the capture module 340 can comprise all or a portion of the image capture device 213 and processor executable instructions associated with the image capture device 213. By way of another example, the image capture device 213 can include all or a portion of the capture module 340. The capture module 340 can be in communication with the communication module 350 to receive the interrupt generated by the generation module 330.

The capture module 340 can capture image data representative of an image (e.g., photograph) to be taken or captured (e.g., using an image sensor of the image capture device 213). In some example embodiments, the capture module 340 can process the image data to aid in associating identities with subjects depicted within the image data. For example, the capture module 340 can enable association (e.g., tagging) of the identities with the subjects depicted within the image.

The communication module 350 enables communication between the device 130, the wearable computing device, and one or more external systems (e.g., a social media site). In some example embodiments, the communication module 350 can enable communication among the receiver module 310, identification module 320, the generation module 330, and the capture module 340. The communication module 350 can be a hardware implemented module, a software implemented module, or a combination thereof, described in more detail below with respect to the module of FIG. 7. For example, the communication module 350 can include communications mechanisms such as an antenna, a transmitter, one or more bus, and other suitable communications mechanisms capable of enabling communication between the modules, the device 130, and the wearable computing device.

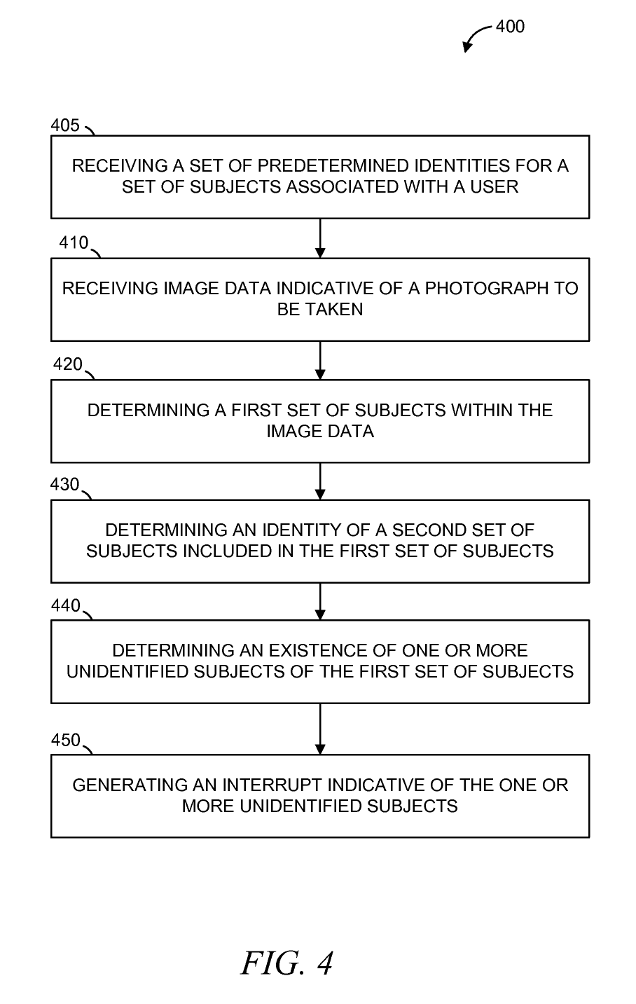

FIG. 4 is a flow chart illustrating operations of the subject identification system 300 in performing a method 400 of determining an identity for one or more subjects within image data of a photograph to be taken and performing an action based on the identity of the subjects within the image data, according to some example embodiments. Operations in the method 400 may be performed by the device 130, using modules described above with respect to FIG. 2.

In some embodiments, in operation 405, the receiver module 310 receives a set of predetermined identities for a set of subjects associated with the user 132. The receiver module 310 can receive the set of predetermined identities directly, for example by uploading a contact list to the device 130, receiving the predetermined identities from social media sites, generating the predetermined identities through use of the method 400 on prior captured images, receiving the predetermined identities as results received in response to a web or other search, combinations thereof, or other suitable methods of receiving the set of predetermined identities. In some embodiments, the receiver module 310 of the subject identification system 300 configures at least one processor among the one or more processors to receive the predetermined identities.

In some embodiments, where the receiver module 310 receives the set of predetermined identities from an upload of a contact list to the device 130, the contact list can include identification information, facial recognition information, wearable device identification information, or any other suitable identifying information for one or more individuals included in the set of subjects. The predetermined identities can include graphical identification information (e.g., pictures), non-graphical information (e.g., text-based or alphanumerically based identification information), combinations thereof, or any other suitable identification information. For example, the user 132 can upload a contact list to the device 130, with the contact list including names and photographs of one or more individuals included in the set of subjects. The contact list can additionally include wearable device identification information such as a media access control address (MAC address) or any other identification information which associates a wearable device with an individual included in the set of subjects. In these embodiments, the identities of the individuals included in the set of subjects can be provided directly to the device 130 by the user 132 or by another individual or group sharing the set of predetermined identities.

In some embodiments, the operation 405 can be performed by the receiver module 310 receiving the set of predetermined identities from one or more social media sites. For example, in some embodiments the server machine 110 can host one or more social media sites, with each site containing a set of subjects, and identifying information for those subjects, with whom the user 132 is associated. The subject identification system 300 can receive the set of predetermined identities from the server machine 110 as a result of a query, an update function, a communication based on a photograph to be taken, combinations thereof, or the like. In some embodiments, the receiver module 310 can receive the set of predetermined identities prior to the user 132 attempting to capture an image and/or prior to the receiver module 310 receiving image data indicative of a photograph to be taken. In some embodiments, the device 130 can receive the set of predetermined identities at the time of capturing an image.

In some embodiments, the operation 405 can be performed by the receiver module 310 or the server machine 110 generating the predetermined identities through use of the method 400 on prior captured images. For example, if no set of subjects and set of predetermined identities are provided to the receiver module 310 or server machine 110, the receiver module 310 or server machine 110 can determine, through a set of captured images, the set of subjects associated with the user 132. The receiver module 310 or the server 110 can then determine the identities of the individuals within the set of subjects via identifying metadata later associated with one or more of the captured images. Where multiple individuals of the set of subjects are identified in a single image, the receiver module 310 or server machine 110 can withhold assignment of an identity to one or more of the multiple individuals until the receiver module 310 or server machine 110 is presented with one or more additional images including one or more of the multiple individuals. For example, where the receiver module 310 receives a first image containing first, second, and third individuals and three names, included in metadata, the device 130 may prevent assignment of the names until after receiving a second image including only the second individual and a third image including only the third individual. Although presented in a simplified case, the device 130 can perform any suitable method of determination, such as algorithms representative of inductive or deductive processes.

In some embodiments, the operation 405 can be performed by the receiver module 310 or the server machine 110 receiving the predetermined identities as results received in response to a web or other search. For example, after receiving captured images indicative of the set of subjects associated with the user 132, the subject identification system 300 can perform an image based web search to supply identity information based on facial recognition matches between the set of subjects and the results from the web search.

In some embodiments, the operation 405 can be performed by the receiver module 310 or the server machine 110 receiving the set of predetermined identities of the set of subjects for a specific photograph to be taken. For example, where the user 132 intends on taking a composed or timed photograph, the user 132 can manually enter the set of predetermined identities of the individuals included in the set of subjects which are to be photographed. In some embodiments, after the receiver module 310 or the server machine 110 has received the set of predetermined identities, the user 132 can provide image data to associate the set of predetermined identities with one or more facial characteristics depicted in the image data.

In operation 410, the receiver module 310 receives image data indicative of a photograph to be taken by the image capture device 213 of the device 130. The receiver module 310 can receive the image data prior to capturing the image data as a photograph. In some embodiments, the receiver module 310 of the subject identification system 300 configures at least one processor among the one or more processors to receive the image data.

In operation 420, the identification module 320 determines a first set of subjects within the image data. The first set of subjects can be determined by face detection operations, outline object recognition operations, operations identifying one or more wearable computing devices associated with a subject (e.g., Bluetooth® discovery, wireless device discovery), determination of body heat (e.g., operations using forward looking infrared (FLIR) cameras), or other operations capable of determining a first set of subjects within the image data. The determination can be made by a processor 202 of the device 130, where the device 130 is configured to perform an action of capturing an image. For example, where the device 130 is a camera or image capture device, the processor 202 can perform the action at any time after receiving the image data. In some embodiments, the device 130 can be temporarily configured to perform the action of capturing the image. For example, in some embodiments, where the device 130 is a smartphone, the device 130 may be temporarily configured to perform the action of capturing an image by software stored on non-transitory machine readable storage media of the device 130, such as when the device 130 is running a camera application. In some embodiments, the identification module 320 of the device 130 configures at least one processor among the one or more processors to determine the first set of subjects.

In operation 430, the identification module 320 determines an identity of a second set of subjects included in the first set of subjects within the image data. The identity of the second set of subjects can be matched to one or more identity of a set of predetermined identities. In some embodiments, in order to determine the identity of the second set of subjects, the identification module 320 can narrow the first set of subjects into the second set of subjects by performing an identification attempt for each subject within the first set of subjects. Subjects, of the first set of subjects, whose identity have been successfully determined, can be grouped within the second set of subjects. In some embodiments, the identification module 320 of the device 130 configures at least one processor among the one or more processors to determine the identity of the second set of subjects.

In some embodiments, the identification module 320 can determine the identity of the second set of subjects based on a facial recognition comparison of each subject of the second set of subjects with facial profiles associated with the set of predetermined identities. The facial profiles can include images, graphical representations, non-graphical representations (e.g., a data set including values representing characteristics of a face), or any other data suitable for use in facial recognition techniques. In some embodiments, the device can determine one or more characteristics of the second set of subjects for comparison with one or more characteristics of the facial profiles associated with the set of predetermined identities. For example, the one or more characteristics can include facial characteristics such as a distance between the eyes, a shape of eyes, a width of a nose, a shape of nose, a depth of eye sockets, a relative height of cheekbones, a shape of cheekbones, a length of jaw line, a shape of jawline, facial measurements and representations from three dimensional images, skin tone, scars, tattoos, or any other suitable characteristic which may be included in a facial profile used for facial recognition.

In some embodiments, the identification module 320 can determine the identity of each of the second set of subjects based on receiving a wearable device identification associated with the set of predetermined identities. In some embodiments, the communication module 350 configures at least one processor among the one or more processors of the device 130 to receive the wearable device identification associated with the set of predetermined identities.

In some embodiments, the identification module 320 can determine the identity of each of the second set of subjects based on user 132 input of the set of predetermined identities. For example, in embodiments where the user 132 has entered the set of predetermined identities of the second set of subjects to be photographed, in a timed or composed photograph, the user 132 can manually assign identities of the set of predetermined identities to individuals included in the second set of subjects, prior to capturing the image as a photograph. By way of further example, the user 132, when setting up the photograph, can use a graphical user interface with an input device, such as a touchscreen of the device 130, to assign the identities to individuals within the image data.

In some embodiments, once the identification module 320 determined the identity of subjects within the second set of subjects, the identification module 320 can include data indicative of the identity of the subjects with the image data. For example, the identification module 320 can append the identity data to the image data as metadata, thereby tagging the image data with the identity of the subjects of the second set of subjects. In some embodiments, the identification module 320 can generate a data file indicative of the identity data and form an association in one or more of the data file and the image data indicating an association of the data file with the image data.

In operation 440, the identification module 320 can determine the existence of one or more unidentified subjects of the first set of subjects within the image data. For example, the identification module 320 can determine that one or more subjects of the first set of subjects cannot be identified by the identification module 320 in operation 430. In this example, the subjects not identified within the second set of subjects may be determined to be one or more unidentified subjects. In some embodiments, the identification module 320 of the subject identification system 300 determines the existence of the one or more unidentified subjects.

In some embodiments, the identification module 320 can determine the existence of the one or more unidentified subjects based on a facial recognition comparison of each subject of the first set of subjects with facial profiles associated with the set of predetermined identities. For example, in some embodiments, the identification module 320 can transmit the image data to the server machine 110, where the server machine 110 performs the facial recognition comparison, as will be explained in more detail below. By way of further example, the identification module 320 can perform a portion of the facial recognition analysis by determining one or more characteristics of the one or more unidentified subjects and transmit data indicative of the one or more characteristics to the server machine 110 for the facial recognition comparison. In some embodiments, the identification module 320 can perform the facial recognition comparison within the device 130.

In operation 450, the generation module 330 generates an interrupt indicative of the one or more unidentified subjects of the first set of subjects. In some embodiments, the interrupt can cause the device 130 to perform one or more actions. In some embodiments, where the interrupt causes the device 130 to perform a plurality of actions, certain of the plurality of actions can be related to capturing the image, while certain of the plurality of actions can be related to a notification of the one or more unidentified subjects. In some embodiments, the generation module 330 of the subject identification system 300 configures at least one processor among the one or more processors to generate the interrupt.

In some embodiments, the interrupt, generated by the generation module 330, can cause the processor of the image capture device to recapture an image. For example, where the generation module 330 determines the existence of the one or more unidentified subjects after capturing an image, the interrupt may cause the device to recapture the image. In some embodiments, the device 130 can perform the operations 420, 430, and 440, and subsequently capture a first image. After capturing the first image, the device can perform the operations 420, 430, and 440 on the first image. After determining the existence of the one or more unidentified subjects within the first image, the interrupt can cause the device 130 to recapture the first image, thereby generating a second image.

In some embodiments, the interrupt, generated by the generation module 330, can cause the processor of the image capture device to generate an alert indicative of an existence of the one or more unidentified subjects within the image data. The alert can be a user perceivable alert, such that the user 132 can perceive the alert indicative of the existence of the one or more unidentified subjects whether the user 132 is holding the device 130 or separated a distance therefrom. For example, the alert can be a light, a noise, a vibration, or other indication produced by the device 130. In some embodiments, the device 130 can be in communication with a wearable device, where the interrupt causes the wearable device to generate the alert, similar to the alerts described above.

In some embodiments, the interrupt, generated by the generation module 330, can cause the processor to delay capturing the image based on a predetermined event. The predetermined event can be chosen from a group consisting of a predetermined time period, a variable time period, and a removal of the one or more unidentified subjects from the image. In some embodiments, the interrupt can cause the device 130 to delay capturing the image without a notification of the delay, while in other embodiments the interrupt can cause the device 130 to generate an alert in combination with the delay. For example, the interrupt can cause the device 130 to generate a light indicative of the delay, with the light remaining on until the predetermined event.

In some embodiments, the interrupt, generated by the generation module 330 can cause the processor to maintain focus on the second set of subjects and prevent focus on the one or more unidentified subjects while capturing the image. In some embodiments, the generation module 330 can prevent focus on the one or more unidentified subjects by causing software stored on the non-transitory machine readable storage medium of the device 130 to blur or otherwise partially obfuscate the one or more unidentified subjects. In some embodiments, the capture module 340 of the subject identification system 300 configures at least one processor among the one or more processors of the device 130 to maintain focus on the second set of subjects, prevent focus on the one or more unidentified subjects, and capture the image.

In some embodiments, the generation module 330 can determine the proximity of the subjects within the image data in order to focus on the second set of subjects. For example, the generation module 330 can determine a first proximity of the second set of subjects and determine a second proximity of the one or more unidentified subjects. The capture module 340 can then focus the camera device on the second set of subjects and prevent focus on the one or more unidentified subjects based on a difference in the first proximity and the second proximity. In some embodiments, the capture module 340 of the subject identification system 300 configures at least one processor among the one or more processors of the device 130 to determine the first proximity and the second proximity, focus the camera device of the device 130 on the second set of subjects, and capture the image.

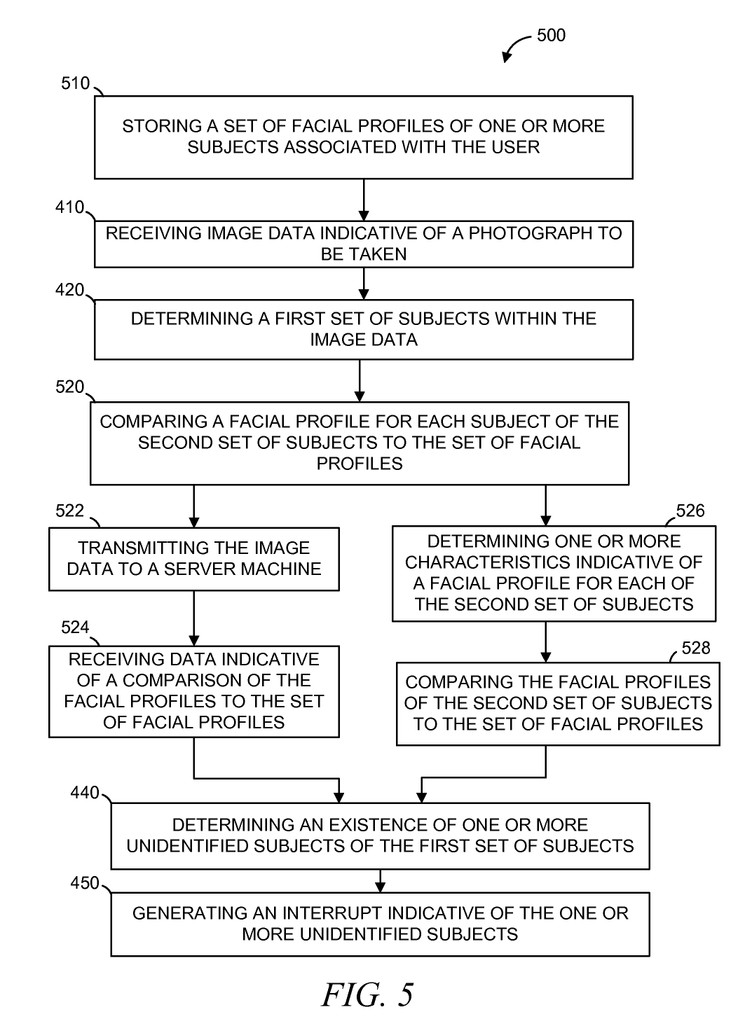

FIG. 5 is a flowchart illustrating operations of the subject identification system 300 in performing a method 500 of determining an identity for one or more subjects within image data of a photograph to be taken and performing an action based on the identity of the subjects within the image data, according to some example embodiments. Operations in the method 500 may be performed by the device 130, using modules described above with respect to FIG. 3

In operation 510, a set of facial profiles of one or more subjects associated with the user is stored on non-transitory machine readable storage media. In some embodiments, the set of facial profiles can be stored on the device 130 and made accessible to the camera device, after being received by the receiver module 310. In some embodiments, the set of facial profiles is stored on the server machine 110 and made available to the device 130 via communication over the network 190.

In operation 520, the identification module 320 compares a facial profile for each subject of the second set of subjects to the set of facial profiles of the one or more subjects associated with the user. The operation 520 can be implemented by the identification module 320 or by communication between the device 130 and the server 110, where the server 110 includes at least a portion of the identification module 320.

For example, in some embodiments where the set of facial profiles is stored on non-transitory machine readable storage media of the server 110, the operation 520 can be represented by operations 522 and 524. In operation 522, the identification module 320 can transmit the image data received in operation 410 to the server machine 110, acting as a facial recognition system. In operation 524, the receiver module 310 or the identification module 320 can receive data indicative of a comparison of the facial profile for each subject of the second set of subjects, within the image data, to the set of facial profiles of the one or more subjects associated with the user.

By way of further example, in some embodiments where the set of facial profiles is stored on non-transitory machine readable storage media of the device 130, the operation 520 can be represented by operations 526 and 528. In operation 526, the identification module 320 can determine one or more characteristics indicative of a facial profile for each subject of the second set of subjects. In operation 528, the identification module 320 can compare the facial profile for each subject of the second set of subjects with the set of facial profiles of the one or more subjects associated with the user.

FIG. 6 is a flowchart illustrating operations of the subject identification system 300 in performing a method 600 of determining an identity for one or more subjects within image data of a photograph to be taken and performing an action based on the identity of the subjects within the image data, according to some example embodiments. Operations in the method 600 may be performed by the device 130, using modules described above with respect to FIG. 3.

In operation 610, in determining the identity of the second set of subjects, the receiver module 310 receives identification data from one or more wearable devices associated with one or more of the second set of subjects.

In operation 620, the identification module 320 compares the identification data with a set of identification data for a set of subjects associated with the user. In some embodiments, the identification data can be received in the operation 405 as part of the data indicative of the set of predetermined identities for the set of subjects associated with the user.

According to various example embodiments, one or more of the methodologies described herein may facilitate identifying unintended subjects in a photograph to be taken and causing an action based on the unintended subjects. Moreover, one or more of the methodologies described herein may facilitate prevention of photobombing, capturing timed photographs, capturing posed photographs, and tagging or otherwise associating identity data with image data or a photograph. Hence, one or more of the methodologies (e.g., operations 440 and 450, operations 520-528, operations 610 and 620, combinations thereof, or other operations) described herein may facilitate capturing photographs without unwanted or unidentified subjects, as well as identifying the subjects of the photograph without user interaction.

When these effects are considered in aggregate, one or more of the methodologies described herein may obviate a need for certain efforts or resources that otherwise would be involved in identifying unintended subjects in a photograph to be taken and causing an action based on the unintended subjects. Efforts expended by a user in preventing photobombing or composing and capturing photographs for a predetermined set of subjects may be reduced by one or more of the methodologies described herein. Computing resources used by one or more machines, databases, or devices (e.g., within the network environment 100) may similarly be reduced. Examples of such computing resources include processor cycles, network traffic, memory usage, data storage capacity, power consumption, and cooling capacity.

FIG. 7 is a block diagram illustrating components of a machine 700, according to some example embodiments, able to read processor executable instructions 724 from a machine-readable medium 722 (e.g., a non-transitory machine-readable medium, a machine-readable storage medium, a computer-readable storage medium, or any suitable combination thereof) and perform any one or more of the methodologies discussed herein, in whole or in part. Specifically, FIG. 7 shows the machine 700 in the example form of a computer system (e.g., a computer) within which the instructions 724 (e.g., software, a program, an application, an applet, an app, or other executable code) for causing the machine 700 to perform any one or more of the methodologies discussed herein may be executed, in whole or in part.

In alternative embodiments, the machine 700 operates as a standalone device or may be communicatively coupled (e.g., networked) to other machines. In a networked deployment, the machine 700 may operate in the capacity of a server machine or a client machine in a server-client network environment, or as a peer machine in a distributed (e.g., peer-to-peer) network environment. The machine 700 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 724, sequentially or otherwise, that specify actions to be taken by that machine. Further, while only a single machine is illustrated, the term “machine” shall also be taken to include any collection of machines that individually or jointly execute the instructions 724 to perform all or part of any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more modules (e.g., software modules) described herein.

The machine 700 may further include a graphics display 710 (e.g., a plasma display panel (PDP), a light emitting diode (LED) display, a liquid crystal display (LCD), a projector, a cathode ray tube (CRT), or any other display capable of displaying graphics or video). The machine 700 may also include an alphanumeric input device 712 (e.g., a keyboard or keypad), a cursor control device 714 (e.g., a mouse, a touchpad, a trackball, a joystick, a motion sensor, an eye tracking device, or other pointing instrument), a storage unit 716, an audio generation device 718 (e.g., a sound card, an amplifier, a speaker, a headphone jack, or any suitable combination thereof), and a network interface device 720.

The storage unit 716 includes the machine-readable medium 722 (e.g., a tangible and non-transitory machine-readable storage medium) on which are stored the instructions 724 embodying any one or more of the methodologies or functions described herein. The instructions 724 may also reside, completely or at least partially, within the main memory 704, within the processor 702 (e.g., within the processor's cache memory), or both, before or during execution thereof by the machine 700. Accordingly, the main memory 704 and the processor 702 may be considered machine-readable media (e.g., tangible and non-transitory machine-readable media). The instructions 724 may be transmitted or received over the network 190 via the network interface device 720. For example, the network interface device 720 may communicate the instructions 724 using any one or more transfer protocols (e.g., hypertext transfer protocol (HTTP)).

In some example embodiments, the machine 700 may be a portable computing device, such as a smart phone or tablet computer, and have one or more additional input components 730 (e.g., sensors or gauges). Examples of such input components 730 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), and an altitude detection component (e.g., an altimeter). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 722 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 724 for execution by the machine 700, such that the instructions 724, when executed by one or more processors of the machine 700 (e.g., processor 702), cause the machine 700 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method, comprising:
receiving image data indicative of an image to be captured;
determining, via a processor of an image capturing device configured to perform an action of capturing an image, a first set of subjects within the image data;
determining an identity of a second set of subjects included in the first set of subjects within the image data, the identity of the second set of subjects matched to one or more identity of a set of predetermined identities;
determining an existence of one or more unidentified subjects of the first set of subjects within the image data; and
generating an interrupt indicative of the one or more unidentified subjects of the first set of subjects.

2. The method of claim 1 further comprising:
receiving the set of predetermined identities for the second set of subjects associated with a user.

3. The method of claim 2, wherein receiving the set of predetermined identities comprises:
receiving the set of predetermined identities from a contact list associated with the image capturing device.

4. The method of claim 2, wherein receiving the set of predetermined identities comprises:
receiving the set of predetermined identities from a social media site.

5. The method of claim 1, wherein the interrupt causes the processor of the image capturing device to recapture an image.

6. The method of claim 1, wherein the interrupt causes the processor of the image capturing device to generate an alert indicative of an existence of the one or more unidentified subjects within the image data.

7. The method of claim 1, wherein the interrupt causes the processor to delay capturing the image based on a predetermined event.

8. The method of claim 7, wherein the predetermined event is chosen from a group consisting of a predetermined time period, a variable time period, a removal of the one or more unidentified subjects from the image data.

9. The method of claim 1, wherein the interrupt causes the processor to maintain focus on the first set of subjects and prevent focus on the one or more unidentified subjects while capturing the image.

10. The method of claim 1 further comprising:
determining a first proximity of the second set of subjects;
determining a second proximity of the one or more unidentified subjects; and
focusing the image capturing based on the second set of subjects based on a difference in the first proximity and the second proximity.

11. The method of claim 1, wherein determining the identity of the second set of subjects further comprises:
receiving identification data from one or more wearable devices associated with one or more of the second set of subjects; and
comparing the identification data with a set of identification data for a set of subjects associated with a user.

12. The method of claim 1, wherein determining the identity of the second set of subjects further comprises:
transmitting the image data to a facial recognition system having data indicative of facial profiles of one or more subjects associated with a user; and
receiving data indicative of a comparison of the image data to the data indicative of the facial profiles.

13. The method of claim 1, wherein determining the identity of the second set of subjects further comprises:
storing, in a non-transitory machine readable storage medium of the image capturing device, a set of facial profiles of one or more subjects associated with a user;
determining one or more characteristics indicative of a facial profile for each subject of the second set of subjects; and
comparing the facial profile for each subject of the second set of subjects with the set of facial profiles of one or more subjects associated with the user.

14. A system, comprising:
a receiver module configured to receive image data indicative of an image to be captured;
an identification module configured to determine a first set of subjects within the image data, determine an identify of a second set of subjects included in the first set of subjects within the image data, matching the identity of the second set of subjects to one or more identity of a set of predetermined identities, and determine an existence of one or more unidentified subjects of the first set of subjects within the image data; and
a generation module configured to generate an interrupt indicative of the one or more unidentified subjects of the first set of subjects.

15. The system of claim 14, wherein to determine the identity of the second set of subjects, the identification module is configured to:
transmit the image data to a facial recognition system having data indicative of facial profiles of one or more subjects associated with a user; and
receive data indicative of a comparison of the image data to the data indicative of the facial profiles.

16. The system of claim 14, wherein to determine the identity of the second set of subjects, the identification module is configured to:
store, in a database associated with the identification module, a set of facial profiles of one or more subjects associated with a user;
determine one or more characteristics indicative of a facial profile for each subject of the second set of subjects; and
compare the facial profile for each subject of the second set of subjects with the set of facial profiles associated with the user.

17. The system of claim 14 further comprising a capture module configured to:
determine a first proximity of the second set of subjects;
determine a second proximity of the one or more unidentified subjects; and
focus an image capturing device on the second set of subjects based on a difference in the first proximity and the second proximity.

18. The system of claim 14, wherein the identification module is configured to:
receive identification data from one or more wearable devices associated with one or more of the second set of subjects; and
compare the identification data with a set of identification data for a set of subjects associated with a user.

19. A non-transitory machine-readable storage medium comprising processor executable instructions that, when executed by a processor of a machine, cause the machine to perform operations comprising:
receiving image data indicative of an image to be captured;
determining a first set of subjects within the image data;
determining an identity of a second set of subjects included in the first set of subjects within the image data, the identity of the second set of subjects matched to one or more identity of a set of predetermined identities;
determining an existence of one or more unidentified subjects of the first set of subjects within the image data; and
generating an interrupt indicative of the one or more unidentified subjects of the first set of subjects.

20. The non-transitory machine-readable storage medium of claim 19, wherein determining the identity of the second set of subjects further comprises:
determining one or more characteristics indicative of a facial profile for each subject of the second set of subjects; and
comparing the facial profile for each subject of the second set of subjects with a set of facial profiles of one or more subjects associated with a user.
